(19) United States
(12) Patent Application Publication
(10) Pub. No.: US 2016/0241535 A1
(43) Pub. Date: Aug. 18, 2016

(54) TERMINAL AUTHENTICATION AND REGISTRATION SYSTEM, METHOD FOR AUTHENTICATING AND REGISTERING TERMINAL, AND STORAGE MEDIUM

(71) Applicant: NEC SOLUTION INNOVATORS, LTD., Tokyo (JP)

(72) Inventor: Yasuki KADOMATSU, Tokyo (JP)

(73) Assignee: NEC Solution Innovators, Ltd., Tokyo (JP)

(21) Appl. No.: 15/026,807

(22) PCT Filed: Aug. 21, 2014
(86) PCT No.: PCT/JP2014/004273

§ 371 Date: Apr. 1, 2016

(30) Foreign Application Priority Data
Oct. 3, 2013 (JP) 2013-208410

(51) Int. Cl. H04L 29/06

(52) U.S. Cl. CPC H04L 63/08; H04L 63/101; H04L 63/102

(57) ABSTRACT

The present invention performs authentication and registration of a user and a terminal in a remote desktop system. A user authentication unit of a remote PC determines whether to permit a user to log in the PC. A terminal information transmission unit of a terminal reads terminal information and transmits the terminal information to the remote PC. A connection permission determination unit determines whether to permit a remote desktop connection between the terminal and the PC, by referring to a white list. When the RD connection is not permitted, a request information generation unit generates request information for requesting to register combination of user information, the terminal information, and computer information. A request information transmission unit transmits the generated request information to a terminal registration device. A registration unit determines, whether to register the combination.

### TECHNICAL FIELD

The present invention relates to a terminal authentication and registration system that authenticates and registers a terminal executing a remote desktop connection (referred to also as “authentication and registration” below), a terminal authentication registration method, and a storage medium.

### BACKGROUND ART

With a wide spread of smart devices, such as tablets and smartphones, there is an increasing need for bring your own device (BYOD) for permitting a user to use their own mobile terminals for work by connecting the terminals to a corporate communication network. At the same time, to bring BYOD into a company, the company needs to administer connections by personal smart devices to the system of the company. With the remote desktop technology (or thin-client technology), a user can connect a terminal to a personal computer (referred to as “PC” below) to do his/her job. Since the remote desktop technology allows a user to do his/her job without saving any job applications or files on his/her terminal, the technology matches well with BYOD.

PTL 1 discloses a thin-client system that performs authentication by using an authentication apparatus for a thin-client terminal and multiple virtual PCs without modifying authentication software.

PTL 2 relates to a technique used by a host apparatus to authenticate a terminal apparatus and discloses an apparatus that simultaneously authenticates a user and a terminal apparatus to simultaneously perform user authentication and terminal apparatus authentication.

### CITATION LIST

### Patent Literature

[PTL 1] Japanese Unexamined Patent Application Publication No. 2002-259001

[PTL 2] Japanese Unexamined Patent Application Publication No. 2008-166927

### SUMMARY OF INVENTION

### Technical Problem

In the remote desktop technology, authentication is performed, at the time of establishing a connection from a terminal to a PC, for the user of the terminal executing the connection but not for the terminal. However, to bring BYOD into a company, the company needs to administer terminals executing such a connection, from the security point of view. To administer terminals executing such a connection, a network authentication technology different from the remote desktop technology needs to be employed in combination with the remote desktop technology. This, however, has the problem of an increase in system complexity, cost, and difficulty of use for users.

The techniques of PTL 1 and PTL 2 are for authenticating a particular terminal attempting to establish a connection to a host computer and are not for authenticating and registering a new unknown terminal.

The present invention mainly aims to authenticate and register a user and a terminal in a remote desktop system without increasing any of system complexity, cost, and difficulty of use for the user.

### Solution to Problem

A terminal authentication and registration system according to a first aspect of the present invention is characterized in that the system includes:

a destination computer capable of authenticating a remote desktop connection by a terminal of a user; and

a terminal registration apparatus configured to register the remote desktop connection between the terminal and the destination computer,

the destination computer including:

a user information acquisition means for acquiring user information identifying the user;

a user authentication means for determining whether or not to permit the user indicated by the user information to log in to the destination computer, with reference to authentication information indicating a user permitted to log in to the destination computer;

a terminal information acquisition means for acquiring terminal information identifying the terminal, from the terminal;

a first white-list storage means for storing a white list, in which a combination of the user, the terminal, and the destination computer, for which a remote desktop connection is permitted, is registered,

a connection permission determination means for determining, when the user authentication means determines to permit the user indicated by the user information to log in to the destination computer, whether or not to permit a remote desktop connection between the terminal indicated by the terminal information and the destination computer by the user indicated by the user information, with reference to the white list;

a request information generation means for generating, when the connection permission determination means determines not to permit the remote desktop connection, request information to be used for requesting to register the combination of the user, the terminal, and the destination computer to the white list, on the basis of the user information, the terminal information, and computer information identifying the destination computer; and

a request information transmission means for transmitting the request information generated by the request information generation means, to the terminal registration apparatus,

the terminal registration apparatus including:

a second white-list storage means for storing the white list;

a condition information storage means for storing condition information indicating a condition for determining whether or not to register the combination of the user, the terminal, and the destination computer to the white list;

a request information reception means for receiving the request information from the destination computer;

a registration means for determining whether or not to register the combination of the user, the terminal, and the destination computer to the white list, with reference to the condition information, on the basis of the request information received by the request information reception means, and updating, when determining to register the combination, the white list by registering the combination of the user, the terminal, and the destination computer to the white list; and

a permission information transmission means for transmitting, when the registration means determines to register the combination, the updated white list to the destination computer, and for transmitting, when the registration means determines not to register the combination, error information indicating that the registration is not permitted, to the destination computer,

the destination computer further including:

a permission information reception means for receiving the error information and the updated white list from the terminal registration apparatus and storing the updated white list in the first white-list storage means; and

an error information output means for outputting the error information received by the permission information reception means.

A terminal authentication and registration method according to a second aspect of the present invention is a method executed in a terminal authentication and registration system including a destination computer capable of authenticating a remote desktop connection by a terminal of a user, and a terminal registration apparatus configured to register the remote desktop connection between the terminal and the destination computer.

The method includes the steps of, performed by the destination computer:

a user information acquisition step of acquiring user information identifying the user;

a user authentication step of determining whether or not to permit the user indicated by the user information to log in to the destination computer, with reference to authentication information indicating a user permitted to log in to the destination computer;

a terminal information acquisition step of acquiring terminal information identifying the terminal, from the terminal;

a connection permission determination step of determining, when it is determined in the user authentication step that the user indicated by the user information is permitted to log in to the destination computer, whether or not to permit a remote desktop connection between the terminal indicated by the terminal information and the destination computer by the user indicated by the user information, with reference to a white list in which a list of a combination of the user, the terminal, and the destination computer, a remote desktop connection being permitted in the combination, is registered;

a request information generation step of generating, when it is determined in the connection permission determination step that the remote desktop connection is not permitted, request information to be used for requesting to register the combination of the user, the terminal, and the destination computer to the white list, on the basis of the user information, the terminal information, and computer information identifying the destination computer; and

a request information transmission step of transmitting the request information generated in the request information generation step, to the terminal registration apparatus.

The method also includes the steps of, performed by the terminal registration apparatus:

a request information reception step of receiving the request information from the destination computer;

a registration step of determining whether or not to register the combination of the user, the terminal, and the destination computer to the white list, with reference to condition information indicating a condition for determining whether or not to register the combination of the user, the terminal, and the destination computer to the white list, on the basis of the request information received in the request information reception step, and updating, when it is determined to register the combination, the white list by registering the combination of the user, the terminal, and the destination computer to the white list; and

a permission information transmission step of transmitting, when it is determined in the registration step to register the combination, the updated white list to the destination computer, and transmitting, when it is determined not to register the combination, error information indicating that the registration is not permitted, to the destination computer.

And the method also includes the steps of, performed by the destination computer:

a permission information reception step of receiving the error information and the updated white list from the terminal registration apparatus and storing the updated white list; and

an error information output step of outputting the error information received in the permission information reception step.

A computer readable storage medium according to a third aspect of the present invention recorded with a computer program is characterized in the computer program causes a computer to function as:

a user information acquisition means for acquiring user information identifying a user;

a user authentication means for determining whether or not to permit the user indicated by the user information to log in a destination computer, with reference to authentication information indicating a user permitted to log in to the destination computer;

a terminal information acquisition means for acquiring, from a terminal of the user, terminal information identifying the terminal;

a white-list storage means for storing a white list in which a list of a combination of the user, the terminal, and the destination computer, a remote desktop connection being permitted in the combination, is registered;

a connection permission determination means for determining, when the user authentication means determines to permit the user indicated by the user information to log in to the destination computer, whether or not to permit a remote desktop connection between the terminal indicated by the terminal information and the destination computer by the user indicated by the user information, with reference to the white list;

a request information generation means for generating, when the connection permission determination means determines not to permit the remote desktop connection, request information to be used for requesting to register the combination of the user, the terminal, and the destination computer to the white list, on the basis of the user information, the terminal information, and computer information identifying the destination computer not permitting the remote desktop connection;

a condition information storage means for storing condition information indicating a condition for determining whether or not to register the combination of the user, the terminal, and the destination computer to the white list;

a registration means for determining whether or not to register the combination of the user, the terminal, and the destination computer to the white list, with reference to the condition information on the basis of the request information, and updating, when determining to register the combination, the white list by registering the combination of the user, the terminal, and the destination computer to the white list;

an error information generation means for generating, when the registration means determines not to register the combination, error information indicating that the registration is not permitted; and

an error information output means for outputting the error information.

A terminal authentication apparatus according to a fourth aspect of the present invention includes:

a user authentication means for acquiring user information identifying a user, and determining whether or not to permit the user indicated by the user information to log in to the own apparatus, with reference to authentication information indicating a user permitted to log in to the own apparatus:

a terminal information acquisition means for acquiring, from a terminal executing a remote desktop connection to the own apparatus, terminal information identifying the terminal;

a first storage means for storing a white list in which a list of a combination of the user, the terminal, and a destination computer to which the terminal executes a remote desktop connection, a remote desktop connection being permitted in the combination, is registered;

a connection permission determination means for determining, when the user authentication means determines to permit the user indicated by the user information to log in to the destination computer, whether or not to permit a remote desktop connection between the terminal indicated by the terminal information and the own apparatus by the user indicated by the user information, with reference to the white list; and

a request information generation means for generating, when the connection permission determination means determines not to permit the remote desktop connection, request information to be used for requesting to register the combination of the user, the terminal, and the own apparatus to the white list, on the basis of the user information, the terminal information, and computer information identifying the own apparatus, and transmitting the generated request information to a terminal registration apparatus configured to register the remote desktop connection between the terminal and the own apparatus.

A terminal authentication method that is performed by an information processing apparatus, according to a fifth aspect of the present invention includes:

acquiring user information identifying a user, and executing user authentication for determining whether or not to permit the user identified by the user information to log in to the own apparatus, on the basis of authentication information indicating a user permitted to log in to the own apparatus;

acquiring, from a terminal executes a remote desktop connection to the own apparatus, terminal information identifying the terminal;

determining, when it is determined in the user authentication that the user indicated by the user information is permitted to log in to the own apparatus, whether or not to permit a remote desktop connection between the terminal indicated by the terminal information and the own apparatus by the user indicated by the user information, with reference to a white list corresponding to a list of a combination of the user, the terminal, and a destination computer with which the terminal executes a remote desktop connection, a remote desktop connection being permitted in the combination;

generating, when it is determined in the determination that the remote desktop connection is not permitted, request information to be used for requesting to register the combination of the user, the terminal, and the own apparatus to the white list, on the basis of the user information, the terminal information, and computer information identifying the own apparatus; and

transmitting the generated request information to a terminal registration apparatus configured to register the remote desktop connection between the terminal and the own apparatus.

A computer-readable storage medium according to the sixth aspect of the present invention is recorded with a computer program. The computer program causes a computer, that functions as a terminal authentication apparatus, to execute:

a user authentication process of acquiring user information identifying a user, and determining whether or not to permit the user identified by the user information to log in to the own apparatus, on the basis of authentication information indicating a user permitted to log in to the own apparatus;

a terminal information acquisition process of acquiring, from a terminal executing a remote desktop connection to the own apparatus, terminal information identifying the terminal;

a connection permission determination process of determining, when it is determined in the user authentication process that the user indicated by the user information is permitted to log in to the own apparatus, whether or not to permit a remote desktop connection between the terminal indicated by the terminal information and the own apparatus by the user indicated by the user information, with reference to a white list corresponding to a list of a combination of the user, the terminal, and a destination computer with which the terminal execute a remote desktop connection, a remote desktop connection being permitted in the combination; and

a request information generation process of generating, when it is determined in the connection permission determination process that the remote desktop connection is not permitted, request information to be used for requesting to register the combination of the user, the terminal, and the own apparatus to the white list, on the basis of the user information, the terminal information, and computer information identifying the own apparatus, and transmitting the generated request information to a terminal registration apparatus configured to register the remote desktop connection between the terminal and the own apparatus.

### Advantageous Effects of Invention

According to the present invention, it is possible to authenticate and register a user and a terminal in a remote desktop system without increasing any of system complexity, cost and difficulty of use for the user.

### BRIEF DESCRIPTION OF DRAWINGS

FIG. 1 is a diagram illustrating an example of a configuration of a terminal authentication and registration system according to a first exemplary embodiment of the present invention.

FIG. 2 is a diagram illustrating an example of a structure of a white list according to the first exemplary embodiment.

FIG. 3 is a flowchart illustrating an example of operations in an authentication request process according to the first exemplary embodiment.

FIG. 4 is a flowchart illustrating an example of operations in a registration process according to the first exemplary embodiment.

FIG. 5 is a diagram illustrating an example of a configuration of a terminal authentication apparatus according to a second exemplary embodiment of the present invention.

FIG. 6 is a block diagram illustrating an example of a hardware configuration of a terminal registration apparatus and a destination computer according to each of the exemplary embodiments of the present invention.

### DESCRIPTION OF EMBODIMENTS

Next, exemplary embodiments of the present invention are described in detail with reference to the drawings. The configurations described in the following exemplary embodiments are merely examples, and the technical scope of the invention of the present application is not limited to the configurations.

### First Exemplary Embodiment

A first exemplary embodiment of the present invention is described below in detail with reference to the drawings. The same or corresponding parts are denoted by the same reference symbols throughout the drawings.

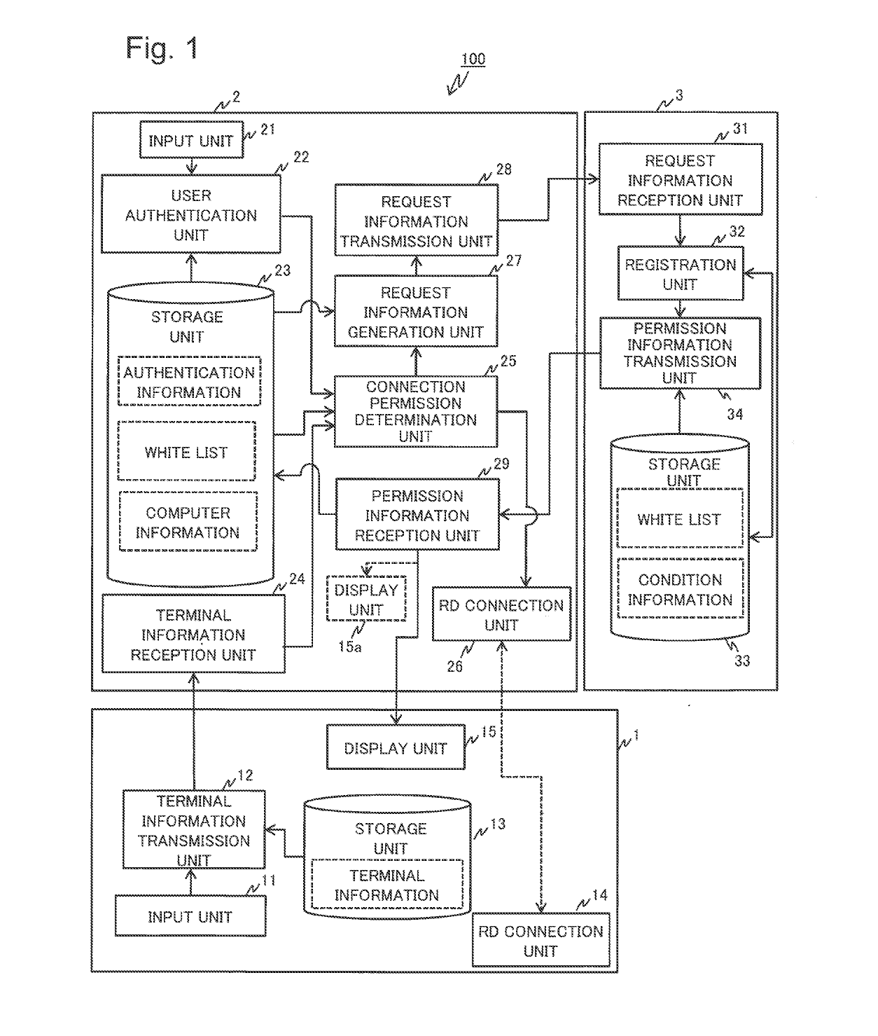

FIG. 1 is a diagram illustrating an example of a configuration of a terminal authentication and registration system according to the first exemplary embodiment of the present invention. A terminal authentication and registration system 100 includes a terminal 1 of a user, a remote PC 2, and a terminal registration apparatus 3. The terminal 1 is a terminal with which the user establishes a remote desktop connection (referred to as “RD connection” below) to a destination computer. The remote PC 2 and the terminal registration apparatus 3 are connected to each other via a communication network (referred to simply as “network” below). The destination computer of the terminal 1 is the remote PC 2.

The remote PC 2 includes an input unit 21, a user authentication unit 22, a storage unit 23, a terminal information reception unit 24, a connection permission determination unit 25, an RD connection unit 26, a request information generation unit 27, a request information transmission unit 28, and a permission information reception unit 29.

When the user directly operates the remote PC 2 via the console of the PC 2 instead of via remote desktop connection, the user inputs user information identifying the user, to the input unit 21 to log in the remote PC 2.

Upon receipt of the input of the user information, the input unit 21 of the remote PC 2 transmits the user information to the user authentication unit 22. The storage unit 23 stores authentication information indicating a user permitted to log in to the remote PC 2. The authentication information may be information that identifies a user permitted to log in to the remote PC 2.

Upon receipt of the user information, the user authentication unit 22 determines (decides) whether or not to permit the log-in by the user indicated by the user information, with reference to the authentication information stored in the storage unit 23. When determining to permit the log-in by the user, the user authentication unit 22 transmits the user information to the connection permission determination unit 25.

The terminal 1 includes an input unit 11, a terminal information transmission unit 12, a storage unit 13, an RD connection unit 14, and a display unit 15.

To establish a remote desktop connection between the terminal 1 and the remote PC 2, the user makes an input of an operation for transmitting terminal information identifying the terminal 1, to the input unit 11. An example of the operation for transmitting the terminal information identifying the terminal 1 is to start a remote desktop function of the terminal 1.

Upon receipt of the operation for transmitting the terminal information, the input unit 11 of the terminal 1 transmits, to the terminal information transmission unit 12, an instruction to transmit the terminal information.

Upon receipt of the instruction to transmit terminal information, the terminal information transmission unit 12 calls up the terminal information from the storage unit 13 and transmits the terminal information to the remote PC 2.

The terminal information includes at least terminal identification information identifying the terminal 1 and also includes, for example, terminal kind information indicating the kind of the terminal 1 and software information indicating the type and version of software installed in the terminal 1.

Upon receipt of the terminal information from the terminal 1, the terminal information reception unit 24 of the remote PC 2 transmits the terminal information to the connection permission determination unit 25. The storage unit 23 stores a white list corresponding to a list storing combinations of a user, a terminal, and a destination computer for which RD connection is permitted. In other words, in the white list, combinations each associating a user, a terminal, and a destination computer for which RD connection is permitted are registered as a list. The format in which data forming the white list is stored is not limited to a list structure, and any appropriate format may be used in each case.

Upon receipt of the user information from the user authentication unit 22 and the terminal information from the terminal information reception unit 24, the connection permission determination unit 25 determines whether or not to permit the RD connection between the terminal 1 of the user and the remote PC 2, with reference to the white list stored in the storage unit 23.

When the user operates the remote PC 2 via the RD connection between the terminal 1 and the remote PC 2, the input unit 11 of the terminal 1 receives an input of the user information, and the terminal information transmission unit 12 transmits the user information to the remote PC 2. The connection permission determination unit 25 of the remote PC 2 receives the user information from the terminal 1, transmits the user information to the user authentication unit 22, and receives a result of user log-in permission determination.

When the combination of the user, the terminal 1, and the remote PC 2 is registered in the white list, the connection permission determination unit 25 determines to permit the RD connection between the terminal 1 of the user and the remote PC 2 and transmits a license key for the RD connection with the terminal 1, to the RD connection unit 26.

Upon receipt of the license key for the RD connection with the terminal 1, the RD connection unit 26 establishes the RD connection with the RD connection unit 14 of the terminal 1.

When the combination of the user, the terminal 1, and the remote PC 2 is not registered in the white list, the connection permission determination unit 25 determines not to permit the RD connection for the combination of the user, the terminal 1, and the remote PC 2 and transmits the user information and the terminal information to the request information generation unit 27. The storage unit 23 stores computer information identifying the remote PC 2.

The request information generation unit 27 generates request information to be used for requesting to register the combination of the user, the terminal 1, and the remote PC 2 to the white list, on the basis of the user information and the terminal information received from the connection permission determination unit 25 and the computer information stored in the storage unit 23. The request information generation unit 27 transmits the generated request information to the request information transmission unit 28. The user may instruct the request information generation unit 27 to generate request information, via the input unit 21.

Upon receipt of the request information, the request information transmission unit 28 transmits the request information to the terminal registration apparatus 3.

The terminal registration apparatus 3 includes a request information reception unit 31, a registration unit 32, a storage unit 33, and a permission information transmission unit 34.

Upon receipt of the request information from the remote PC 2, the request information reception unit 31 transmits the request information to the registration unit 32. The storage unit 33 stores the white list and condition information indicating a condition for deciding (determining) whether or not to register the combination of the user, the terminal 1, and the destination computer to the white list (whether or not to permit the registration).

The condition information may be, for example, information specifying the maximum number n of terminals 1 possible to be registered for a single user or information specifying the type and version of installed security software. Alternatively, the condition information may be information indicating that registration is not permitted when high-risk software, such as file-sharing software, is installed. The condition information may be information specifying the kind of a terminal for which registration is permitted. The condition information may be information indicating that, when request information indicating the registered combination of a registered user, the terminal 1, and the remote PC 2 is received, the registration is not permitted on the basis of the determination that the registered information has an error. The condition information may be other than the above examples.

Upon receipt of the request information, the registration unit 32 determines whether or not to register the combination to the white list, with reference to the condition information stored in the storage unit 33. When the registration unit 32 receives an input from a system manager, the system manager may browse request information and input whether or not to permit the registration to the white list.

When determining to permit the registration to the white list, the registration unit 32 registers the combination of the user, the terminal 1, and the remote PC 2 indicated by the request information, to the white list stored in the storage unit 33. The registration unit 32 transmits the updated white list to the permission information transmission unit 34. In the transmission, the registration unit 32 may transmit difference data between the white lists in view of the processing speed and reduction in load.

When determining not to permit the registration to the white list, the registration unit 32 generates error information indicating that the registration is not permitted, and transmits the generated error information to the permission information transmission unit 34.

The permission information transmission unit 34 transmits, to the remote PC 2, the white list (difference data) and the error information received from the registration unit 32.

When receiving the white list (difference data) from the terminal registration apparatus 3, the permission information reception unit 29 of the remote PC 2 updates the white list stored in the storage unit 23, on the basis of the received white list. In contrast, when receiving the error information from the terminal registration apparatus 3, the permission information reception unit 29 transmits the error information to the terminal 1.

The display unit 15 of the terminal 1 displays the received error information and notifies the user that the registration of the terminal 1 is not permitted. The mode of outputting the error information is not limited to screen display and may be audio output or be registered as log information in the storage unit 13. Alternatively, the display unit configured to display the error information may be included in the remote PC 2, as a display unit 15a indicated by broken lines in FIG. 1.

The white list may be stored in one of the terminal registration apparatus 3 and the remote PC 2. When only the terminal registration apparatus 3 stores the white list, it is assumed that the remote PC 2 is virtually storing the white list by accessing the terminal registration apparatus 3 and referring to the white list. When only the remote PC 2 stores the white list, it is assumed that the terminal registration apparatus 3 is virtually storing the white list by accessing the remote PC 2 and referring to the white list. In the latter case, update of the white list by the remote PC 2 is prohibited, and only the terminal registration apparatus 3 is capable of editing the white list.

The connection permission determination unit 25 of the remote PC 2 may determine, for a user not permitted to log in to the remote PC 2, not to permit the RD connection for the combination of the user, the terminal 1, and the remote PC 2, and transmit, to the request information generation unit 27, the user information on the user not permitted to log in to the remote PC 2 and the terminal information. In this case, the request information generation unit 27 generates deletion request information to be used for requesting to delete the user not permitted to log in to the remote PC 2, the terminal 1, and the remote PC 2 from the white list, on the basis of the user information and the terminal information received from the connection permission determination unit 25 and the computer information stored in the storage unit 23. The request information transmission unit 28 transmits the deletion request information to the terminal registration apparatus 3.

The request information reception unit 31 of the terminal registration apparatus 3 receives the deletion request information from the remote PC 2. The registration unit 32 deletes, from the white list, the combination of the user, the terminal 1, and the remote PC 2 indicated by the deletion request information. The permission information transmission unit 34 transmits the updated white list (difference data) to the remote PC 2.

FIG. 1 illustrates a concrete example with the single remote PC 2 and the single terminal 1. However, it is also applicable to a case with multiple remote PCs 2 and multiple terminals 1.

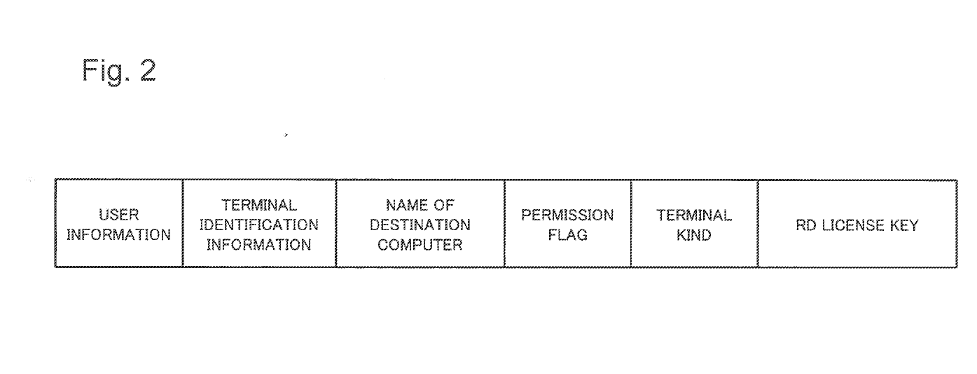

FIG. 2 is a diagram illustrating an example of a structure of the white list according to the first exemplary embodiment.

The white list includes:

“user information” identifying a user and “terminal identification information” identifying the terminal 1;

“name of destination computer” identifying the destination computer to which the terminal 1 is executing an RD connection;

“permission flag” indicating connection permit or cut-off for the RD connection between the terminal 1 and the destination remote PC 2; and

“terminal kind” indicating the kind of the terminal 1 and “RD license key” indicating the license key for the RD connection with the terminal 1.

“User information” is, for example, a user identifier (ID). “Terminal identification information” is, for example, a unique identification number of a terminal. “Name of destination computer” is, for example, the name of the remote PC 2. “Terminal kind” is, for example, a console, iOS (registered trade mark), or Android (registered trademark). For example, when “terminal kind” is a console, “permission flag” may constantly indicate connection permit.

When determining to permit to register the combination to the white list, the registration unit 32 of the terminal registration apparatus 3 makes an input to each item of the white list on the basis of the user information, the terminal information, and the computer information included in the request information. In this operation, when the combination is to be added to the white list, the registration unit 32 newly assigns “RD license key”. When replacing, with the terminal 1, a different terminal 1 already registered in the white list, no change needs to be made to corresponding “RD license key”.

In the example in FIG. 2, the white list consists of “user information”, “terminal identification information”, “name of destination computer”, “permission flag”, “terminal kind”, and “RD license key”. However, “permission flag”, terminal kind”, and “RD license key” do not need to be included in the white list. When “RD license key” is not included in the white list, the connection permission determination unit 25 transmits information indicating that the RD connection by the terminal 1 is permitted, to the RD connection unit 26, and the RD connection unit 26 executes the RD connection.

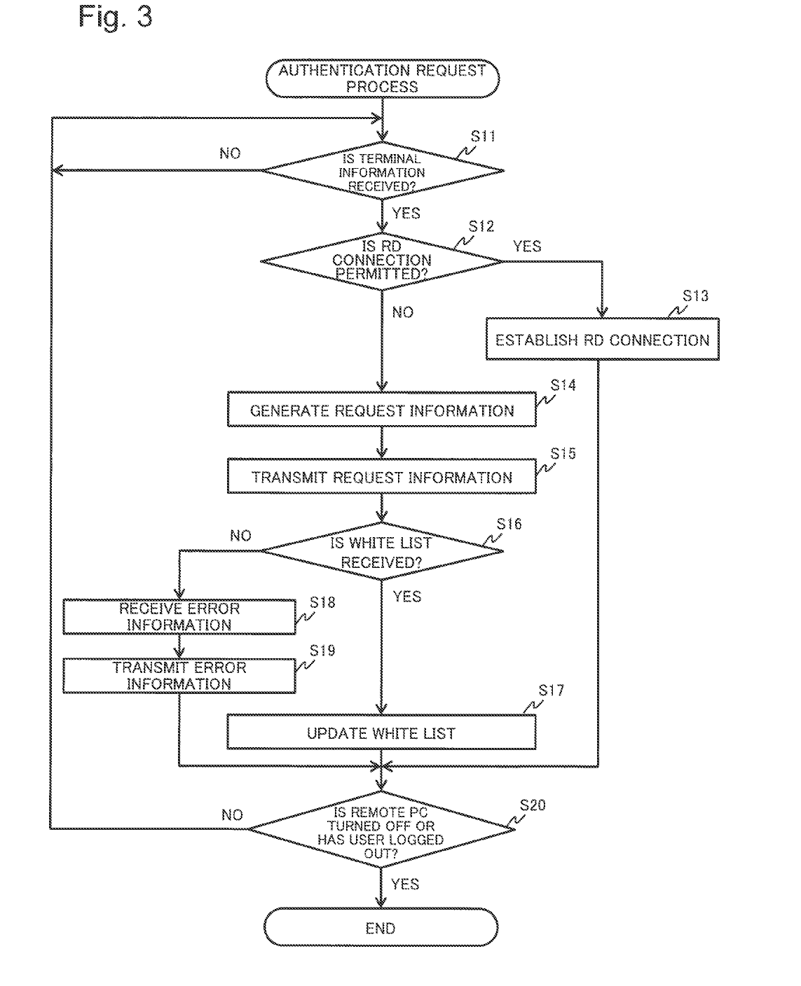

FIG. 3 is a flowchart illustrating an example of operations in an authentication request process according to the first exemplary embodiment. The authentication request process in the flowchart in FIG. 3 is started when a user accesses the remote PC 2.

When not receiving terminal information from the terminal 1 (No in Step S11), the terminal information reception unit 24 of the remote PC 2 waits until terminal information is received, while repeating Step S11. When receiving terminal information from the terminal 1 (Yes in Step S11), the terminal information reception unit 24 transmits the terminal information to the connection permission determination unit 25.

Upon receipt of user information and the terminal information, the connection permission determination unit 25 determines whether or not to permit the RD connection between the terminal 1 indicated by the terminal information and the remote PC 2 by the user indicated by the user information, with reference to the white list stored in the storage unit 23 (Step S12). When permitting the RD connection (Yes in Step S12), the connection permission determination unit 25 transmits the license key for the RD connection with the terminal 1, to the RD connection unit 26.

Upon receipt of the license key for the RD connection with the terminal 1, the RD connection unit 26 establishes the RD connection with the connection unit 14 of the terminal 1 (Step S13), and the process advances to Step S20.

When not permitting the RD connection (No in Step S12), the connection permission determination unit 25 transmits the user information and the terminal information to the request information generation unit 27.

The request information generation unit 27 generates request information for requesting to register the terminal 1 to the white list, on the basis of the user information and the terminal information received from the connection permission determination unit 25 and computer information stored in the storage unit 23 (Step S14). The request information generation unit 27 transmits the generated request information to the request information transmission unit 28.

Upon receipt of the request information, the request information transmission unit 28 transmits the request information to the terminal registration apparatus 3 (Step S15).

When receiving a white list (difference data) from the terminal registration apparatus 3 (Yes in Step S16), the permission information reception unit 29 updates the white list stored in the storage unit 23, on the basis of the received white list (Step S17).

When not receiving a white list (difference data) from the terminal registration apparatus 3 (No in Step S16) but then receiving error information from the terminal registration apparatus 3 (Step S18), the permission information reception unit 29 transmits the error information to the terminal 1 (Step S19). The display unit 15 of the terminal 1 displays the received error information.

When the remote PC 2 is not turned off and the user has not logged out (No in Step S20), the terminal information reception unit 24 continues the process from Step S11. Then, Step S11 to Step S20 described above are repeated. When the remote PC 2 is turned off and the connection is canceled (Yes in Step S20), the components of the remote PC 2 terminate the process.

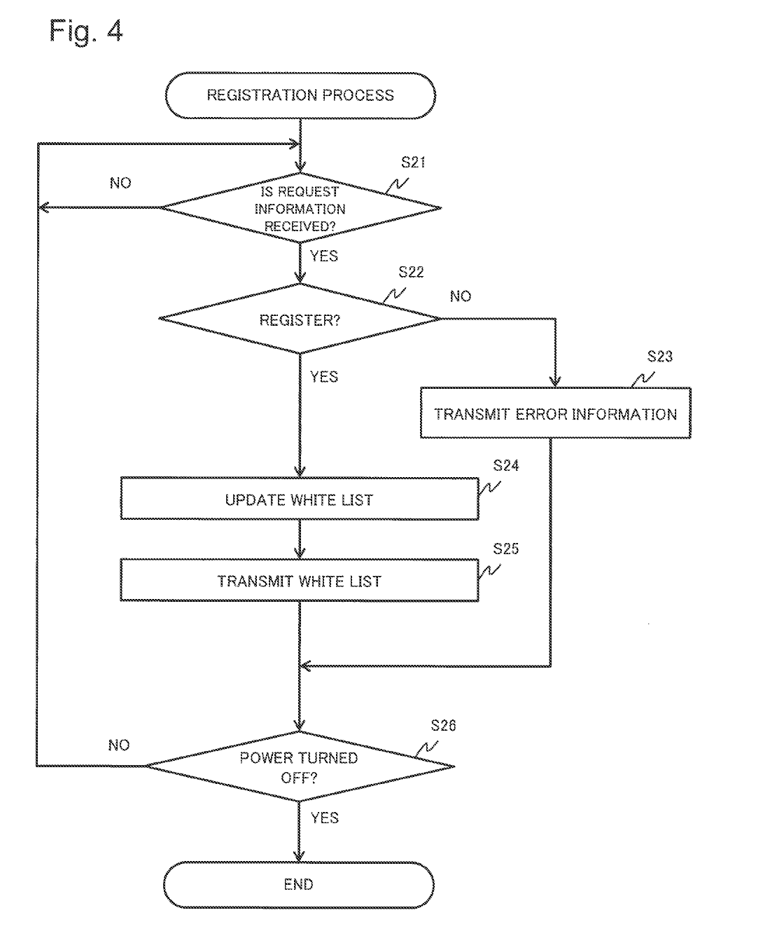

FIG. 4 is a flowchart illustrating an example of operations of a registration process according to the first exemplary embodiment. The registration process in the flowchart in FIG. 4 starts when the terminal registration apparatus 3 is started.

When not receiving request information from the remote PC 2 (No in Step S21), the request information reception unit 31 of the terminal registration apparatus 3 waits until request information is received, while repeating Step S21. When receiving request information from the terminal 1 (Yes in Step S21), the request information reception unit 31 transmits the request information to the registration unit 32.

Upon receipt of the request information, the registration unit 32 determines, with reference to the condition information stored in the storage unit 33, whether or not to register the combination of the user, the terminal 1, and the remote PC 2 indicated by the request information, to the white list (Step S22).

When determining not to register the combination to the white list (No in Step S22), the registration unit 32 generates error information indicating that the registration is not permitted, and transmits the generated error information to the permission information transmission unit 34. The permission information transmission unit 34 transmits the error information to the remote PC 2 (Step S23).

When determining to register the combination to the white list (Yes in Step S22), the registration unit 32 updates the white list by registering, to the white list, the combination of the user, the terminal 1, and the remote PC 2 indicated by the request information (Step S24). The registration unit 32 also transmits the updated white list to the permission information transmission unit 34. The permission information transmission unit 34 transmits the updated white list to the remote PC 2 (Step S25).

When the terminal registration apparatus 3 is not turned off (No in Step S26), the process returns to Step S21, and Step S21 to Step S26 are repeated. When the terminal registration apparatus 3 is turned off (Yes in Step S26), the process is terminated.

The terminal authentication registration system 100 in the above-described exemplary embodiment is capable of authenticating and registering a user and a terminal in a remote desktop system, without increasing system complexity, cost, and difficulty of use for the user.

In the above-described first exemplary embodiment, terminal information is transmitted by connecting the terminal 1 and the remote PC 2. However, the configuration of the terminal authentication and registration system 100 is not limited to this, and may be a configuration in which terminal information is transmitted to a certain mail address by use of a mail function of the terminal 1. In this case, the remote PC 2 receives the mail and acquires the terminal information. In this way, connection of the unknown terminal 1 to a company system does not need to be executed before the use of the terminal 1 in the company system is permitted, which consequently increases security.

### Second Exemplary Embodiment

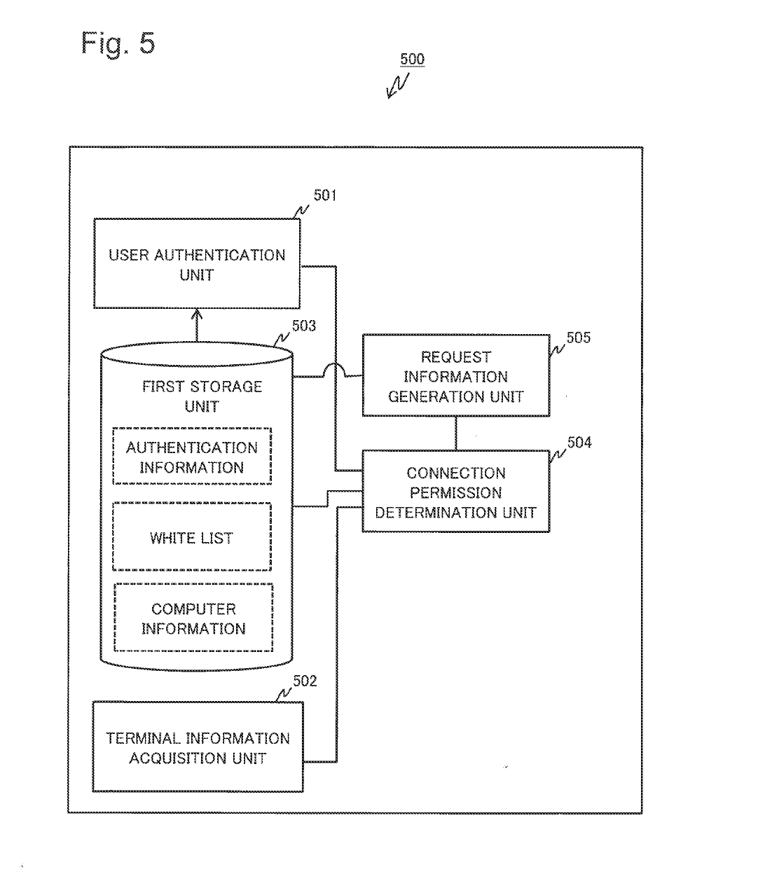

A terminal authentication apparatus 500 according to a second exemplary embodiment of the present invention is described below with reference to FIG. 5.

The terminal authentication apparatus 500 according to this exemplary embodiment includes a user authentication unit 501, a terminal information acquisition unit 502, a first storage unit 503, a connection permission determination unit 504, and a request information generation unit 505. These components of the terminal authentication apparatus 500 according to this exemplary embodiment may be communicably connected to each other via any communication line or the like. Description is given below of the components.

The user authentication unit 501 acquires user information identifying a user, and determines whether or not to permit the user identified by the user information, to log in to the terminal authentication apparatus 500, on the basis of authentication information indicating a user permitted to log in the terminal authentication apparatus 500. The user authentication unit 501 may be similar to the user authentication unit 22 of the first exemplary embodiment, for example.

The terminal information acquisition unit 502 acquires, from a (any) terminal executing a remote desktop connection to the terminal authentication apparatus 500, terminal information identifying the terminal. The terminal information acquisition unit 502 may be similar to the terminal information reception unit 24 of the above-described first exemplary embodiment, for example.

The first storage unit 503 stores a white list corresponding to a list storing combination of the user, the terminal, and the destination computer to which the terminal executes a remote desktop connection for which combination a remote desktop connection is permitted. The destination computer to which the terminal executes a remote desktop connection may be the terminal authentication apparatus 500. The first storage unit 503 may store the authentication information. The first storage unit 503 may be similar to the storage unit 23 of the above-described first exemplary embodiment, for example.

When the user authentication unit 501 determines to permit log-in by the user indicated by the user information, the connection permission determination unit 504 refers to the white list. The connection permission determination unit 504 determines whether or not to permit the remote desktop connection between the terminal indicated by the terminal information and the terminal authentication apparatus 500 by the user indicated by the user information, on the basis of the information in the referred white list. The connection permission determination unit 504 may be similar to the connection permission determination unit 25 of the above-described first exemplary embodiment, for example.

When the connection permission determination unit 504 determines not to permit the remote desktop connection, the request information generation unit 505 executes the following process. Specifically, on the basis of the user information, the terminal information, and computer information identifying the terminal authentication apparatus 500, the request information generation unit 505 generates request information to be used for requesting to register the combination of the user, the terminal, and the apparatus itself to the white list. The request information generation unit 505 transmits the generated request information to a terminal registration apparatus that registers the remote desktop connection between the terminal and the terminal authentication apparatus 500. The request information generation unit 505 may function, for example, as the request information generation unit 27 and the request information transmission unit 28.

The terminal authentication apparatus 500 of this exemplary embodiment having the above-described configuration can authenticate and register a user and a terminal in a remote desktop system without increasing system complexity, cost, and difficulty of use for the user.

This is because authentication and registration of a new terminal is possible by generating, when a terminal executes a remote desktop connection to a destination computer, a permission request to request permission for the terminal to establish a remote desktop connection and transmitting the request to the terminal registration apparatus.

<Hardware and Software (Computer Program) Configurations>

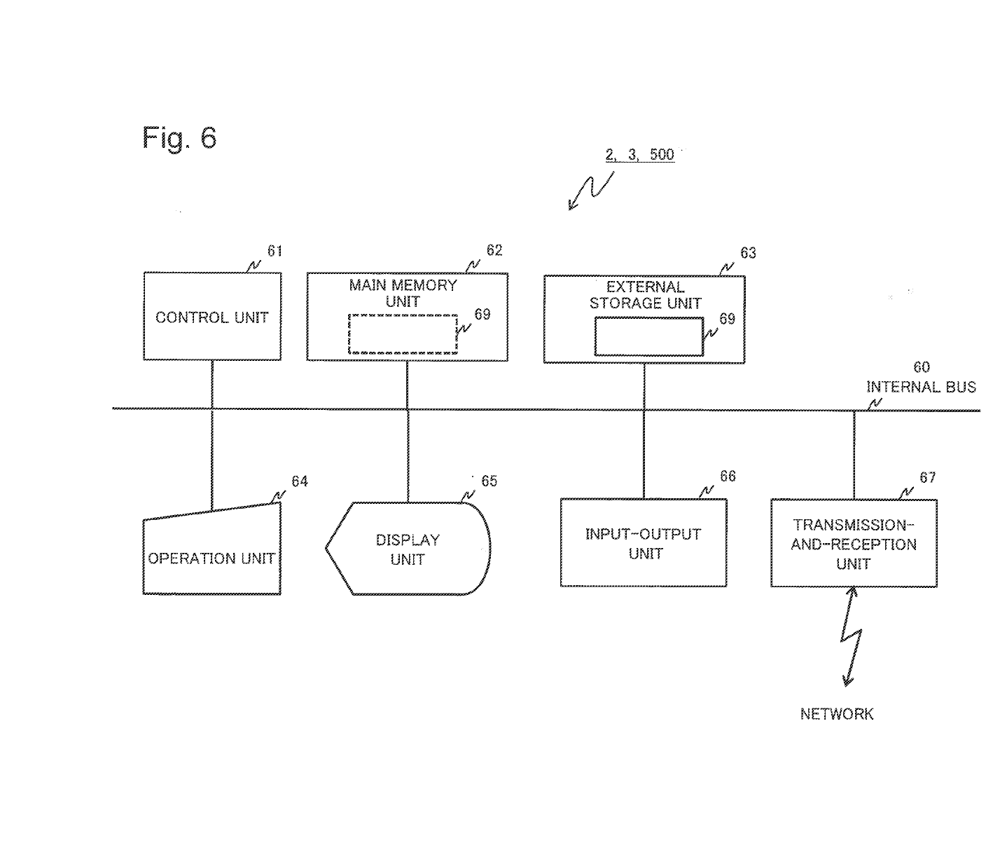

FIG. 6 is a block diagram illustrating an example of a hardware configuration that can implement the terminal registration apparatus and the destination computer according to the exemplary embodiments of the present invention. Hardware that can implement the remote PC 2, the terminal registration apparatus 3, and the terminal authentication apparatus 500 includes, as illustrated in FIG. 6, a control unit 61, a main memory unit 62, an external storage unit 63, an operation unit 64, a display unit 65, an input-output unit 66, and a transmission-and-reception unit 67. The main memory unit 62, the external storage unit 63, the operation unit 64, the display unit 65, the input-output unit 66, and the transmission-and-reception unit 67 are communicably connected to the control unit 61 via an internal bus 60.

The control unit 61 is configured of a central processing unit (CPU) or the like and executes the processes in the user authentication unit 22, the connection permission determination unit 25, the RD connection unit 26, the request information generation unit 27, and the permission information reception unit 29 of the remote PC 2 as well as the registration unit 32 of the terminal registration apparatus 3 in accordance with a control program 69 stored in the external storage unit 63.

The control unit 61 is configured of a central processing unit (CPU) or the like and may also execute the processes by the user authentication unit 501, the connection permission determination unit 504, and the request information generation unit 505 of the terminal authentication apparatus 500 in accordance with the control program 69 stored in the external storage unit 63.

The main memory unit 62 is configured of a random-access memory or the like, and is used as a work area of the control unit 61. The control program 69 stored in the external storage unit 63 is loaded into the main memory unit 62.

The external storage unit 63 is configured of a nonvolatile memory, such as a flash memory, hard disk, a digital versatile disc random-access memory (DVD-RAM), or a digital versatile disc rewritable (DVD-RW). The external storage unit 63 stores, in advance, a program for causing the control unit 61 to execute the processes by the remote PC 2, the terminal registration apparatus 3, or the terminal authentication apparatus 500. The external storage unit 63 provides data stored by the program to the control unit 61, according to an instruction by the control unit 61, and stores data provided by the control unit 61. The storage unit 23 of the remote PC 2, the first storage unit 503 of the terminal authentication apparatus 500, and the storage unit 33 of the terminal registration apparatus 3 is configured by using the external storage unit 63.

The operation unit 64 is configured of a keyboard, a pointing device, such as a mouse, or the like, and an interface apparatus connecting the keyboard and the pointing device or the like to the internal bus 60. When the user directly inputs information to the remote PC 2 or the terminal registration apparatus 3, the input information is provided to the control unit 61 via the operation unit 64. The operation unit 64 functions as the input unit 21 of the remote PC 2.

The display unit 65 is configured of a cathode ray tube (CRT) or a liquid crystal display (LCD) or the like. When the user directly inputs information to the remote PC 2 or the terminal registration apparatus 3, the display unit 65 displays an operation screen. When the remote PC 2 includes a display unit, the display unit 65 functions as the display unit.

The input-output unit 66 is configured of a serial interface or a parallel interface. When a different apparatus is attached to the remote PC 2 or the terminal registration apparatus 3, the input-output unit 66 is connected with the different apparatus.

The transmission-and-reception unit 67 is configured of a network termination apparatus connected to a network or a wireless communication apparatus, a serial interface connected to the apparatus, or a local area network (LAN) interface, and the like. The transmission-and-reception unit 67 functions as the terminal information reception unit 24, the request information transmission unit 28, and the permission information reception unit 29 of the remote PC 2, or request information reception unit 31 and the permission information transmission unit 34 of the terminal registration apparatus 3. The transmission-and-reception unit 67 may function as the terminal information acquisition unit 502 and the request information generation unit 505 of the terminal authentication apparatus 500.

Each of the processes by the input unit 21, the user authentication unit 22, the storage unit 23, the terminal information reception unit 24, the connection permission determination unit 25, the RD connection unit 26, the request information generation unit 27, the request information transmission unit 28, and the permission information reception unit 29 of the remote PC 2, or the request information reception unit 31, the registration unit 32, the storage unit 33, and the permission information transmission unit 34 of the terminal registration apparatus 3 illustrated in FIG. 1 is executed by the control program 69 by using, as resources, the control unit 61, the main memory unit 62, the external storage unit 63, the operation unit 64, the display unit 65, the input-output unit 66, the transmission-and-reception unit 67, and the like.

Each of the processes by the user authentication unit 501, the terminal information acquisition unit 502, the request information generation unit 505, and the connection permission determination unit 504 of the terminal authentication apparatus 500 illustrated in FIG. 5 is executed by the control program 69 by using, as resources, the control unit 61, the main memory unit 62, the external storage unit 63, the operation unit 64, the display unit 65, the input-output unit 66, the transmission-and-reception unit 67, and the like.

The above-described hardware configuration and flowcharts are provided as examples, and changes and modifications can be made to the hardware configuration and flowcharts.

The central part, that is configured by the control unit 61, the main memory unit 62, the external storage unit 63, the internal bus 60, and the like that executes the control process, is not limited to any specific system, and can be implemented by use of a general computer system. The terminal authentication and registration system for executing the above-described processes may be configured, for example, by distributing a computer-readable recording medium (such as a flexible disk, a CD-ROM, or a DVD-ROM) in which a computer program for executing the above-described operations is stored, and installing the computer program in a computer. Alternatively, the terminal authentication and registration system may be configured by a general computer system downloading the computer program stored in a storage apparatus of a server apparatus on a communication network, such as the Internet.

When the functions of the terminal authentication and registration system is implemented by sharing functions between an operating system (OS) and an application program or by cooperation among an OS and an application program, only the part implemented by the application program may be stored in a recording medium (storage medium) or a storage apparatus.

Alternatively, the computer program may be superposed on a carrier and distributed via a communication network. For example, the computer program may be distributed via a communication network by posting the computer program to a bulletin board system (BBS) on the communication network. The above-described processes may be executed by running the computer program and executing the computer program under the control by the OS in a manner similar to those for other application programs.

The invention of the present application is described above with reference to the exemplary embodiments. However, the invention of the present application is not limited to the exemplary embodiments. Various changes may be made to the configuration and details of the invention of the present application, by those skilled in the art, within the scope of the invention of the present application.

This application claims the benefit based on Japanese Patent Application No. 2013-208410, filed on Oct. 3, 2013, the entire disclosure of which is incorporated herein.

### INDUSTRIAL APPLICABILITY

The present invention is applicable to a system providing remote desktop connection.

### REFERENCE SIGNS LIST

1 Terminal
2 Remote PC
3 Terminal registration apparatus
11 Input unit
12 Terminal information transmission unit
13 Storage unit
14 RD connection unit
15 Display unit
21 Input unit
22 User authentication unit
23 Storage unit
24 Terminal information reception unit
25 Connection permission determination unit
26 RD connection unit
27 Request information generation unit
28 Request information transmission unit
29 Permission information reception unit
31 Request information reception unit
32 Registration unit
33 Storage unit
34 Permission information transmission unit
60 Internal bus
61 Control unit
62 Main storage unit
63 External storage unit
64 Operation unit
65 Display unit
66 Input-output unit
67 Transmission-and-reception unit
69 Control program
100 Terminal authentication and registration system
500 Terminal authentication apparatus
501 User authentication unit
502 Terminal information acquisition unit
503 First storage unit
504 Connection permission determination unit
505 Request information generation unit

1. A terminal authentication and registration system comprising:
a destination computer capable of authenticating a remote desktop connection by a terminal of a user; and
a terminal registration apparatus configured to register the remote desktop connection between the terminal and the destination computer,
the destination computer comprising:
a user information acquisition unit configured to acquire user information identifying the user;
a user authentication unit configured to determine whether or not to permit the user indicated by the user information to log in to the destination computer, with reference to authentication information indicating a user permitted to log in to the destination computer;
a terminal information acquisition unit configured to acquire terminal information identifying the terminal, from the terminal;
a first white-list storage unit configured to store a white list, in which a combination of the user, the terminal, and the destination computer, for which a remote desktop connection is permitted, is registered,
a connection permission determination unit configured to determine, when the user authentication unit determines to permit the user indicated by the user information to log in to the destination computer, whether or not to permit a remote desktop connection between the terminal indicated by the terminal information and the destination computer by the user indicated by the user information, with reference to the white list;
a request information generation unit configured to generate, when the connection permission determination unit determines not to permit the remote desktop connection, request information to be used for requesting to register the combination of the user, the terminal, and the destination computer to the white list, on the basis of the user information, the terminal information, and computer information identifying the destination computer; and
a request information transmission unit configured to transmit the request information generated by the request information generation unit, to the terminal registration apparatus,
the terminal registration apparatus comprising:
a second white-list storage unit to store the white list;
a condition information storage unit to store condition information indicating a condition for determining whether or not to register the combination of the user, the terminal, and the destination computer to the white list;
a request information reception unit configured to receive the request information from the destination computer;
a registration unit configured to determine whether or not to register the combination of the user, the terminal, and the destination computer to the white list, with reference to the condition information, on the basis of the request information received by the request information reception unit, and to update, when determining to register the combination, the white list by registering the combination of the user, the terminal, and the destination computer to the white list; and
a permission information transmission unit configured to transmit, when the registration unit determines to register the combination, the updated white list to the destination computer, and to transmit, when the registration unit determines not to register the combination, error information indicating that the registration is not permitted, to the destination computer,
the destination computer further comprising:
a permission information reception unit configured to receive the error information and the updated white list from the terminal registration apparatus and to store the updated white list in the first white-list storage unit; and
an error information output unit configured to output the error information received by the permission information reception unit.

2. The terminal authentication and registration system according to claim 1, wherein the terminal information acquisition unit receives the terminal information transmitted from the terminal to a certain mail address.

3. A terminal authentication and registration method executed in a terminal authentication and registration system including a destination computer capable of authenticating a remote desktop connection by a terminal of a user, and a terminal registration apparatus configured to register the remote desktop connection between the terminal and the destination computer,
the method comprising the steps of, performed by the destination computer:
a user information acquisition step of acquiring user information identifying the user;
a user authentication step of determining whether or not to permit the user indicated by the user information to log in to the destination computer, with reference to authentication information indicating a user permitted to log in to the destination computer;
a terminal information acquisition step of acquiring terminal information identifying the terminal, from the terminal;
a connection permission determination step of determining, when it is determined in the user authentication step that the user indicated by the user information is permitted to log in to the destination computer, whether or not to permit a remote desktop connection between the terminal indicated by the terminal information and the destination computer by the user indicated by the user information, with reference to a white list in which a list of a combination of the user, the terminal, and the destination computer, a remote desktop connection being permitted in the combination, is registered;
a request information generation step of generating, when it is determined in the connection permission determination step that the remote desktop connection is not permitted, request information to be used for requesting to register the combination of the user, the terminal, and the destination computer to the white list, on the basis of the user information, the terminal information, and computer information identifying the destination computer; and
a request information transmission step of transmitting the request information generated in the request information generation step, to the terminal registration apparatus,
the method comprising the steps of, performed by the terminal registration apparatus:
a request information reception step of receiving the request information from the destination computer;
a registration step of determining whether or not to register the combination of the user, the terminal, and the destination computer to the white list, with reference to condition information indicating a condition for determining whether or not to register the combination of the user, the terminal, and the destination computer to the white list, on the basis of the request information received in the request information reception step, and updating, when it is determined to register the combination, the white list by registering the combination of the user, the terminal, and the destination computer to the white list; and
a permission information transmission step of transmitting, when it is determined in the registration step to register the combination, the updated white list to the destination computer, and transmitting, when it is determined not to register the combination, error information indicating that the registration is not permitted, to the destination computer, and
the method further comprising the steps of, performed by the destination computer:
a permission information reception step of receiving the error information and the updated white list from the terminal registration apparatus and storing the updated white list; and
an error information output step of outputting the error information received in the permission information reception step.

4. The terminal authentication and registration method according to claim 3, wherein, in the terminal information acquisition step, the terminal information transmitted from the terminal to a certain mail address is received.

5. A computer-readable storage medium recorded with a program, the program causing a computer to function as:
a user information acquisition unit configured to acquire user information identifying a user;
a user authentication unit configured to determine whether or not to permit the user indicated by the user information to log in a destination computer, with reference to authentication information indicating a user permitted to log in to the destination computer;
a terminal information acquisition unit configured to acquire, from a terminal of the user, terminal information identifying the terminal;
a white-list storage unit configured to store a white list in which a list of a combination of the user, the terminal, and the destination computer, a remote desktop connection being permitted in the combination, is registered;
a connection permission determination configured to determine, when the user authentication unit determines to permit the user indicated by the user information to log in to the destination computer, whether or not to permit a remote desktop connection between the terminal indicated by the terminal information and the destination computer by the user indicated by the user information, with reference to the white list;
a request information generation unit configured to generate, when the connection permission determination unit determines not to permit the remote desktop connection, request information to be used for requesting to register the combination of the user, the terminal, and the destination computer to the white list, on the basis of the user information, the terminal information, and computer information identifying the destination computer not permitting the remote desktop connection;
a condition information storage unit to store condition information indicating a condition for determining whether or not to register the combination of the user, the terminal, and the destination computer to the white list;
a registration unit configured to determine whether or not to register the combination of the user, the terminal, and the destination computer to the white list, with reference to the condition information on the basis of the request information, and to update, when determining to register the combination, the white list by registering the combination of the user, the terminal, and the destination computer to the white list;
an error information generation unit configured to generate, when the registration unit determines not to register the combination, error information indicating that the registration is not permitted; and
an error information output unit configured to output the error information.

6. A terminal authentication apparatus comprising:
a user authentication unit configured to acquire user information identifying a user, and to determine whether or not to permit the user indicated by the user information to log in to the own apparatus, with reference to authentication information indicating a user permitted to log in to the own apparatus:
a terminal information acquisition configured to acquire, from a terminal executing a remote desktop connection to the own apparatus, terminal information identifying the terminal;
a first storage unit configured to store a white list in which a list of a combination of the user, the terminal, and a destination computer to which the terminal executes a remote desktop connection, the remote desktop connection being permitted in the combination, is registered;
a connection permission determination unit configured to determine, when the user authentication unit determines to permit the user indicated by the user information to log in to the destination computer, whether or not to permit a remote desktop connection between the terminal indicated by the terminal information and the own apparatus by the user indicated by the user information, with reference to the white list; and
a request information generation unit configured to generate, when the connection permission determination unit determines not to permit the remote desktop connection, request information to be used for requesting to register the combination of the user, the terminal, and the own apparatus to the white list, on the basis of the user information, the terminal information, and computer information identifying the own apparatus, and to transmit the generated request information to a terminal registration apparatus configured to register the remote desktop connection between the terminal and the own apparatus.

7. The terminal authentication apparatus according to claim 6, further comprising:
a permission information reception unit configured to receive, from the terminal registration apparatus, error information, indicating that the registration of the remote desktop connection between the terminal and the own apparatus is not permitted, or a list of the combination of the user, the terminal, and the destination computer to which the terminal executes a remote desktop connection for which combination a remote desktop connection is permitted, when registration of the remote desktop connection between the terminal and the own apparatus is permitted, the permission information reception unit storing, the list in the first storage unit when receiving the list; and
an error information output unit configured to output the error information received by the permission information reception unit.

8. The terminal authentication apparatus according to claim 7, wherein,
when the terminal registration apparatus stores the white list, the permission information reception unit receives, from the terminal registration apparatus, a difference of the white list updated in the terminal registration apparatus when registration of the remote desktop connection between the terminal and the own apparatus is permitted, and stores the difference in the first storage unit.

9. A terminal registration apparatus that registers a remote desktop connection between a terminal of a user and a destination computer that is the terminal authentication apparatus according to claim 6, the terminal registration apparatus comprising:
a second storage unit configured to store a white list that is a list of a combination of the user, the terminal, and the destination computer, the remote desktop connection being permitted in the combination;
a condition information storage unit configured to store condition information indicating a condition for determining whether or not to register the combination of the user, the terminal, and the destination computer to the white list;
a request information reception for unit configured to receive, from the destination computer, request information to be used for requesting to register the combination of the user, the terminal, and the destination computer to the white list;
a registration unit configured to determine whether or not to register the combination of the user, the terminal, and the destination computer to the white list, with reference to the condition information on the basis of the request information received by the request information reception means, and to update, when determining to register the combination, the white list by registering the combination of the user, the terminal, and the destination computer to the white list; and
a permission information transmission unit configured to transmit, when the registration unit determines to register the combination, the updated white list to the destination computer, and to transmit, when the registration means determines not to register the combination, error information indicating that the registration is not permitted, to the destination computer.

10. The terminal registration apparatus according to claim 9, wherein the permission information transmission unit transmits, when the registration unit determines to register the combination of the user, the terminal, and the destination computer to the white list, a difference between the white list before the update by the registration unit and the white list after the registration, to the destination computer.

11. A terminal authentication method that is performed by an information processing apparatus, comprising:
acquiring user information identifying a user, and executing user authentication for determining whether or not to permit the user identified by the user information to log in to the own apparatus, on the basis of authentication information indicating a user permitted to log in to the own apparatus;
acquiring, from a terminal executes a remote desktop connection to the own apparatus, terminal information identifying the terminal;
determining, when it is determined in the user authentication that the user indicated by the user information is permitted to log in to the own apparatus, whether or not to permit a remote desktop connection between the terminal indicated by the terminal information and the own apparatus by the user indicated by the user information, with reference to a white list corresponding to a list of a combination of the user, the terminal, and a destination computer with which the terminal executes a remote desktop connection, a remote desktop connection being permitted in the combination;
generating, when it is determined in the determination that the remote desktop connection is not permitted, request information to be used for requesting to register the combination of the user, the terminal, and the own apparatus to the white list, on the basis of the user information, the terminal information, and computer information identifying the own apparatus; and
transmitting the generated request information to a terminal registration apparatus configured to register the remote desktop connection between the terminal and the own apparatus.

12. A non-transitory computer-readable storage medium recorded with a computer program, the computer program causing a computer functioning as a terminal authentication apparatus to execute:
a user authentication process of acquiring user information identifying a user, and determining whether or not to permit the user identified by the user information to log in to the own apparatus, on the basis of authentication information indicating a user permitted to log in to the own apparatus;
a terminal information acquisition process of acquiring, from a terminal executing a remote desktop connection to the own apparatus, terminal information identifying the terminal;
a connection permission determination process of determining, when it is determined in the user authentication process that the user indicated by the user information is permitted to log in to the own apparatus, whether or not to permit a remote desktop connection between the terminal indicated by the terminal information and the own apparatus by the user indicated by the user information, with reference to a white list corresponding to a list of a combination of the user, the terminal, and a destination computer with which the terminal execute a remote desktop connection, a remote desktop connection being permitted in the combination; and
a request information generation process of generating, when it is determined in the connection permission determination process that the remote desktop connection is not permitted, request information to be used for requesting to register the combination of the user, the terminal, and the own apparatus to the white list, on the basis of the user information, the terminal information, and computer information identifying the own apparatus, and transmitting the generated request information to a terminal registration apparatus configured to register the remote desktop connection between the terminal and the own apparatus.
